(19) United States
(12) Patent Application Publication
(10) Pub. No.: US 2004/0117844 A1
(43) Pub. Date: Jun. 17, 2004

(54) Television providing indications relating to non-broadcast information when in inactive mode

(76) Inventors: Jeyhan Karaoguz, Irvine, CA (US); James D. Bennett, Laguna Beach, CA (US)

Correspondence Address: MCANDREWS HELD & MALLOY, LTD, 500 WEST MADISON STREET, SUITE 3400, CHICAGO, IL, 60661

(21) Appl. No.: 10/675,090

(22) Filed: Sep. 30, 2003

Related U.S. Application Data
(60) Provisional application No. 60/478,288, filed on Jun. 13, 2003.
(60) Provisional application No. 60/444,098, filed on Jan. 30, 2003.
(60) Provisional application No. 60/443,996, filed on Jan. 30, 2003.
(60) Provisional application No. 60/448,705, filed on Feb. 18, 2003.
(60) Provisional application No. 60/432,472, filed on Dec. 11, 2002.
(60) Provisional application No. 60/443,894, filed on Jan. 30, 2003.

(51) Int. Cl. H04N 7/173; H04N 7/16; H04N 9/16

(52) U.S. Cl. 725/112; 725/113; 725/135; 348/808

(57) ABSTRACT

Systems and methods for managing newly accessible media content on a communication network are provided. In one embodiment, a system may comprise, for example, a display, a communication network, and media content. The display may be communicatively coupled to at least one communication device. The communication device may be in at least one of a “standby” mode and an “off” mode. The communication network may be communicatively coupled to the at least one communication device. The media content may be disposed in at least one of the communication network and the at least one communication device. The at least communication device may be adapted to detect the media content that is newly accessible to the at least one communication device and to provide indications relating to the detection of the newly available media content. The indications may be provided on at least one of the display and the at least one communication device.

### CROSS-REFERENCE TO RELATED APPLICATIONS/INCORPORATION BY REFERENCE

This application makes reference to, claims priority to, and claims the benefit of U.S. Provisional Patent Application No. 60/478,288 (attorney docket number 14445US01) filed on Jun. 13, 2003, U.S. Provisional Patent Application No. 60/444,098 (attorney docket number 14283US01), filed Jan. 30, 2003, U.S. Provisional Patent Application No. 60/443,996 (attorney docket number 14281US01), filed Jan. 30, 2003, and U.S. Provisional Patent Application No. 60/448,705 (attorney docket number 14330US01), filed Feb. 18, 2003, U.S. Provisional Application No. 60/432,472, entitled “Personal Inter-Home Media Exchange Network” (Attorney Docket No. 14185US01 01001P-BP-2800), filed Dec. 11, 2002, and U.S. Provisional Application No. 60/443,894, entitled “Personal Access And Control Of Media Peripherals On A Media Exchange Network” (Attorney Docket No. 14274US01 01002P-BP-2801), filed Jan. 30, 2003, the complete subject matter of which are hereby incorporated herein by reference, in their entirety.

In addition, the applicants hereby incorporate the complete subject matter herein by reference, in their entirety, of U.S. Provisional Patent Application Serial No. 60/457,179, entitled “Server Architecture Supporting A Personal Media Exchange Network” (Attorney Docket No. 14825US01 01015P-BP-2831), filed Mar. 25, 2003, U.S. patent application Ser. No. __/___,___, entitled “Personal Inter-Home Media Exchange Network” (Attorney Docket No. 14185US02 01001P-BP-2800), filed Sep. 8, 2003, and U.S. patent application Ser. No __/___,___, entitled “Personal Access And Control Of Media Peripherals On A Media Exchange Network” (Attorney Docket No. 14274US02 01002P-BP-2801), filed Sep. 11, 2003, the complete subject matter of which are hereby incorporated herein by reference, in their entirety.

### FEDERALLY SPONSORED RESEARCH OR DEVELOPMENT

[Not Applicable]

### SEQUENCE LISTING

[Not Applicable]

### MICROFICHE/COPYRIGHT REFERENCE

[Not Applicable]

### BACKGROUND OF THE INVENTION

An email subscriber must log in periodically to check whether email has arrived. Email sent by other subscribers accumulates at the service provider, until the subscriber connects and retrieves it. Some email software may provide visual or audible notice of the availability or arrival of email, but this is provided only when the computer is both on and connected to the email service provider. The notice to the user is usually in the form of an audio tone or voice message emanating from the speaker of the computer. If the computer used for email retrieval is turned off, enters standby mode, or if the user is away from the computer, there is no mechanism for the service provider to notify a user that email is available. A similar problem exists for recipients of other non-broadcast media content.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

Aspects of the present invention may be found in, for example, systems and methods for managing newly accessible media content on a communication network. A system in accordance with an embodiment of the present invention may comprise, for example, a display, a communication network, and media content. The display may be communicatively coupled to at least one communication device. The communication device may be in at least one of a “standby” mode and an “off” mode. The communication network may be communicatively coupled to the at least one communication device. The media content may be disposed in at least one of the communication network and the at least one communication device. The at least communication device may be adapted to detect the media content that is newly accessible to the at least one communication device and to provide indications relating to the detection of the newly available media content. The indications may be provided on at least one of the display and the at least one communication device.

In another embodiment, the system may comprise, for example, at least one processor disposed in a communication device. The communication device may be in a “standby” mode and communicatively coupled to a communication network. The at least one processor may detect newly accessible media content on the communication network. The at least one processor may further provide indications relating to the detection of newly available media content.

In another embodiment, a method in accordance with the present invention may comprise, for example, one or more of the following: detecting newly available media content by a communication device in at least one of a “standby” mode and an “off” mode, the communication device communicatively coupled to a communication network; and generating at least one indication relating to the detection of newly available media content.

In another embodiment, a method in accordance with the present invention may comprise, for example, one or more of the following: detecting newly accessible media content by a communication device, the communication device communicatively coupled to a communication network; displaying a notice relating to the availability of the newly accessible media content on a text display, the text display communicatively coupled to the communication device; activating at least one of an integrated television and an external television; and displaying a graphic notice for the availability of the newly accessible media content on at least one of the integrated television and the external television.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a diagram illustrating a media exchange network 100 in which an embodiment of the present invention may be practiced.

FIG. 1B is a diagram illustrating an exemplary embodiment of a media exchange network supporting a media processing system that provides indications relating to non-broadcast information when in inactive mode, in accordance with the present invention.

FIG. 1C is a diagram illustrating another exemplary embodiment of a media exchange network supporting a media processing system that provides indications relating to non-broadcast information when in inactive mode, in accordance with the present invention.

FIG. 2 is a flowchart illustrating an exemplary method of operating a media processing system providing indications relating to non-broadcast information when in an inactive mode, in accordance with the present invention.

FIG. 3 is a schematic block diagram of a first exemplary media exchange network in accordance with an embodiment of the present invention.

FIG. 4 is a schematic block diagram of performing personal media exchange over a second exemplary media exchange network in accordance with an embodiment of the present invention.

FIG. 5 is a schematic block diagram of performing third-party media exchange over a third exemplary media exchange network in accordance with an embodiment of the present invention.

FIG. 6 is an exemplary illustration of a media guide user interface in accordance with an embodiment of the present invention.

FIG. 7 is an exemplary illustration of several instantiations of a media guide user interface of FIG. 4 in accordance with an embodiment of the present invention.

FIG. 8 is an exemplary illustration of a media guide user interface showing several options of a pushed media in accordance with an embodiment of the present invention.

FIG. 9A is a schematic block diagram of a media processing system (MPS) interfacing to media capture peripherals in accordance with an embodiment of the present invention.

FIG. 9B illustrates an alternative embodiment of a media processing system (MPS) in accordance with various aspects of the present invention.

FIG. 10 is a schematic block diagram of a PC and an MPS interfacing to a server on a media exchange network in accordance with an embodiment of the present invention.

FIG. 11 is a schematic block diagram of a PC interfacing to personal media capture devices and remote media storage on a media exchange network in accordance with an embodiment of the present invention.

### DETAILED DESCRIPTION OF THE INVENTION

Certain embodiments of the present invention relate to a mechanism for alerting a user of a communication network. In particular, certain embodiments of the present invention enable a media processing system to provide notification to a user of the availability of media channel content accessible via a media exchange network.

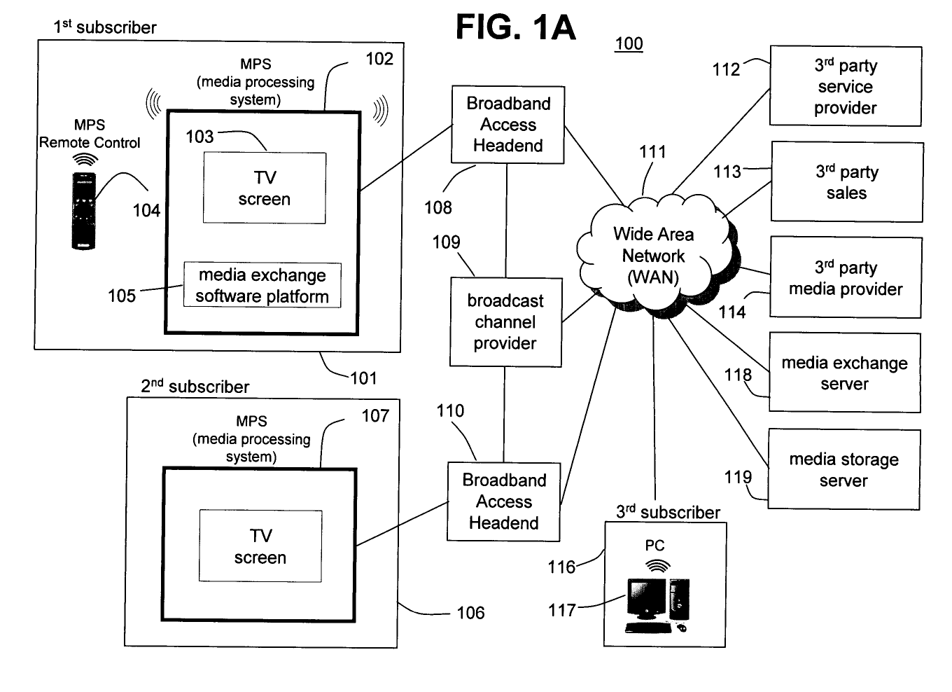

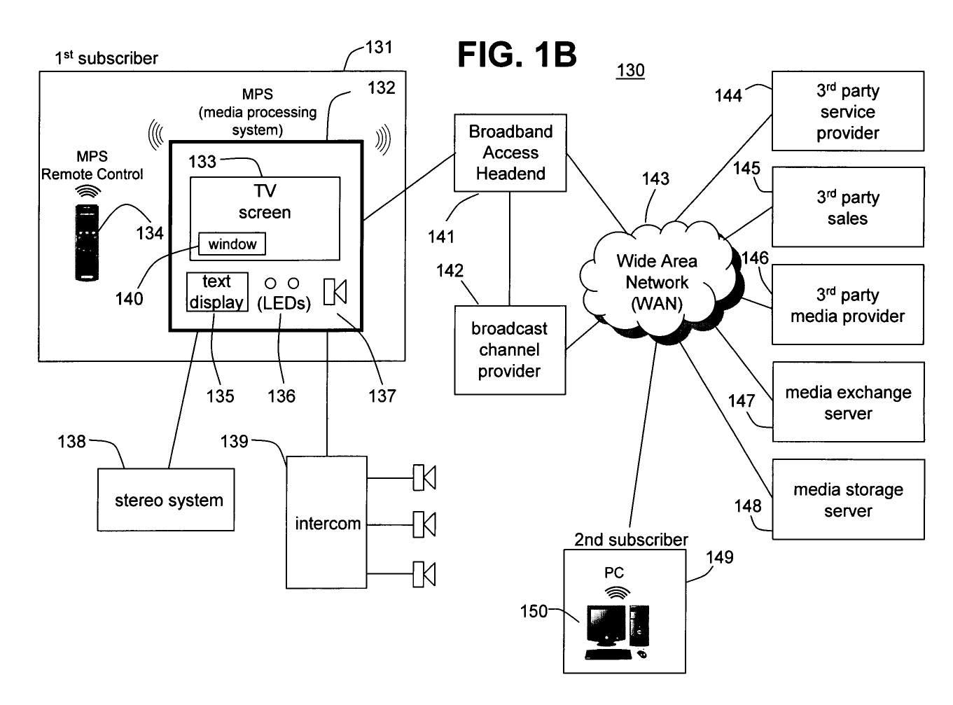

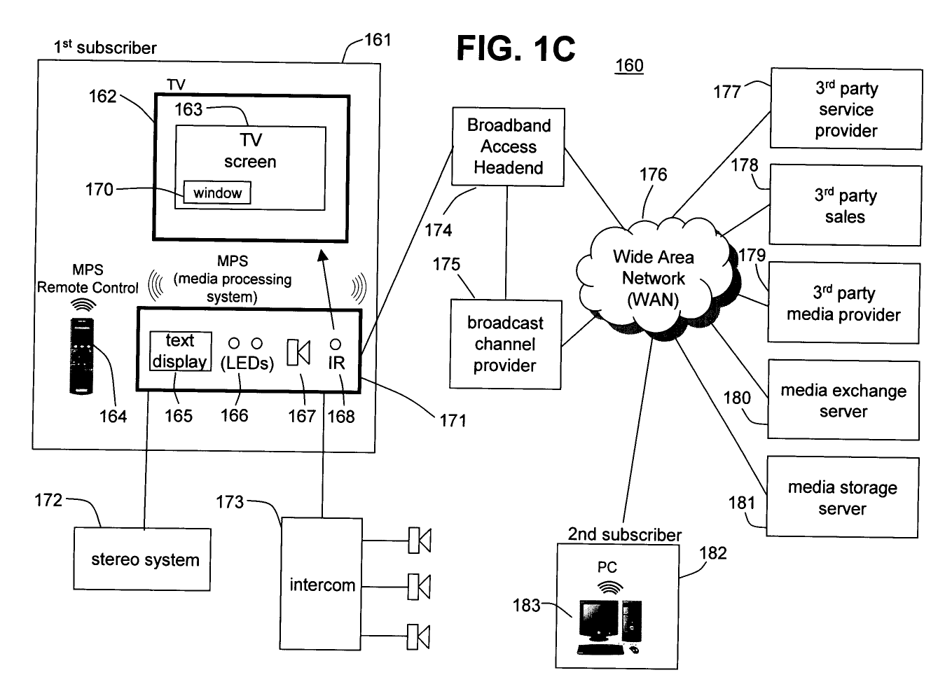

FIG. 1A is a diagram illustrating a media exchange network 100 in which an embodiment of the present invention may be practiced. The media exchange network 100 is a communication network comprising an MPS (media processing system) 102 at a 1st subscriber 101, an MPS 107 at a 2^{nd} subscriber 106, and a PC 117 at a third subscriber 116. The MPS 102 is connected to broadband access headend 108 which connects to WAN infrastructure 111. Likewise, the MPS 107 is connected to broadband access headend 110 which provides connectivity to WAN infrastructure 111. The media exchange network 100 further comprises a 3^{rd} party service provider 112, a 3^{rd} party sales provider 113, a 3^{rd} party media provider 114, a media exchange server 118, a media storage server 119, and a broadcast channel provider 109. Wide-area network (WAN) infrastructure 111 provides connectivity between the MPS's 102, 107 and the PC 117, and permits access to 3^{rd} party service provider 112, 3^{rd} party sales provider 113, 3^{rd} party media provider 114, the media exchange server 118, the media storage server 119, and broadcast channel provider 109. The fact that illustration of FIG. 1A shows two MPS's 102, 107 and a single PC 117 is not intended to represent a limitation of the present invention. The media exchange network 100 may comprise any number of MPS's and PC's without departing from the spirit and scope of the present invention.

The MPS's 102, 107 may be, for example, enhanced set-top boxes. The MPS's 102, 107 may each include a TV screen such as the TV screen 103 of the MPS 102 for viewing and interacting with various user interfaces, media, data, and services that are available on the media exchange network 100 using, for example, a remote control such as the remote control 104 associated with the MPS 102. The PC 117 may include a PC monitor for viewing and interacting with various user interfaces, media, data, and services that are available on the media exchange network using, for example, a keyboard and mouse. The MPS's 102, 107 and the PC 117 include functional software to support interaction with the various elements of the media exchange network 100, in accordance with various embodiments of the present invention.

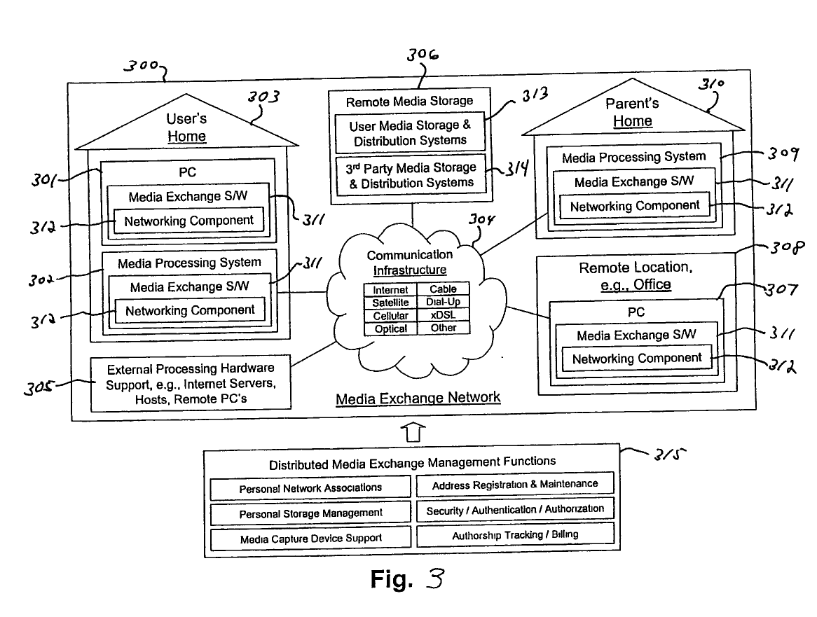

For example, the MPS's 102, 107 and the PC 117 comprise a media exchange software (MES) platform 105. Further details of a media exchange software platform are provided below with respect to FIG. 3. The MES platform 105 on the MPS 102, and similarly the MES platforms on MPS 107 and PC 117, support personalized views of media channels and the set up of new media channels on the media exchange network 100. For example, the MES platform 105 provides a format, displayed on a monitor of the MPS 102, comprising a media guide user interface to allow a user to set up a personalized view of the media guide user interface using a remote control 104. An example media guide user interface is described in U.S. Provisional Patent Application Serial No. 60/448,705, filed Feb. 18, 2003, the complete subject matter of which is hereby incorporated herein, in its entirety. The MES platform 105 also provides the functionality for a user of the MPS 102 to set up one or more media channels in his personalized view.

In general, the MPS's 102, 107 and the PC 117 each include a media exchange software (MES) platform and a networking component for connectivity. The MES platform provides multiple capabilities including media “push” capability, media “access” capability, media channel construction/selection, image sequence selection, text and voice overlay, channel and program naming, inter-home routing selection, authorship and media rights management, shared inter-home media experience, billing service, and an integrated media guide interface with a TV channel guide look-and-feel.

In accordance with various embodiments of the present invention, an MPS may comprise a set-top box (STB), a PC, or a TV with a media management system (MMS). An MMS is also known herein as a media exchange software (MES) platform.

An MMS comprises a software platform operating on at least one processor to provide certain functionality including user interface functionality, distributed storage functionality, and networking functionality. For example, a MMS may provide control of media peripheral devices, status monitoring of media peripheral devices, and inter-home MPS routing selection, in accordance with an embodiment of the present invention.

FIG. 1B is a diagram illustrating an exemplary embodiment of a media exchange network 130 supporting a media processing system 132 that provides indications relating to non-broadcast information when in inactive mode, in accordance with the present invention. Similar to the media exchange network 100 of FIG. 1A, the media exchange network 130 of FIG. 1B comprises an MPS 132 at a 1st subscriber 131 and a PC 150 at a 2^{nd} subscriber 149. The media exchange network 130 further comprises a 3^{rd} party service provider 144, a 3^{rd} party sales provider 145, a 3^{rd} party media provider 146, a media exchange server 147, a media storage server 148, and a broadcast channel provider 142. The WAN infrastructure 143 provides connectivity between the MPS 132 and the PC 150, and permits access to 3^{rd} party service provider 144, 3^{rd} party sales provider 145, media exchange server 147, media storage server 148, and 3^{rd} party media provider 146. The WAN infrastructure 143 may comprise, for example, a wired infrastructure, a wireless infrastructure, an intranet infrastructure, an Internet infrastructure, a digital subscriber loop (DSL) infrastructure, or any combination of the above. Although the illustration of FIG. 1B shows a particular complement of MPS's and PC's, the present invention is not limited in this regard.

As in the exemplary media exchange network of FIG. 1A, the MPS 132 may be, for example, an enhanced set-top box and may include a TV screen 133 and a remote control 134, similar to the TV screen 103 and remote control 104 of the MPS 102 of FIG. 1A. The PC 150 may include a PC monitor, a keyboard, and mouse. The MPS 132 and the PC 150 include functional software to support interaction with the various elements of the media exchange network 130, in accordance with various embodiments of the present invention.

In the embodiment shown in the illustration of FIG. 1B, the MPS 132 has been depicted as a media processing system 132 with an integrated TV screen 133. The MPS 132 of FIG. 1B comprises TV screen 133, text display 135, light emitting diodes (LED's) 136, and speaker 137. Stereo system 138 and intercom 139 are connected to the MPS 132. The user may employ the MPS 132 to consume previously scheduled or newly available media channel content provided by other entities connected to media exchange network 130 such as, for example, broadcast channel provider 142, 3^{rd} party service provider 144, 3^{rd} party sales provider 145, 3^{rd} party media provider 146, media exchange server 147, media storage server 148, and 2^{nd} subscriber 149. Media channel content may be arranged for viewing/listening using a media guide interface, such as the media guide interface referenced above. A method enabling automatic access to newly available media in a media exchange network is described in U.S. Provisional Patent Application Serial No. 60/443,996, filed Jan. 30, 2003, the complete subject matter of which is hereby incorporated herein, in its entirety.

The media processing system 132 may operate in one of several states such as, for example, the “on”, “off”, “idle”, and “standby” states. During normal user access to media exchange network 130, the MPS 132 is operated in the “on” state, in which the integrated TV screen 133 is illuminated and used to display, for example, selected media channel content or a user media guide interface. When in the “on” state, the user may be notified of the availability of media channel content other than that being displayed using pop-up window 140. Although shown in FIG. 1B as a distinct display region, the window 140 may be, for example, a ghost overlay or other screen display technique to make the user of the MPS 132 aware of the availability of media channel content. The media processing system 132 may also use, for example, the connections to stereo system 138 or the intercom 139 to provide an audible announcement of the availability of media content. In order to utilize the stereo system 138, the MPS 132 may use a wired or wireless link to arrange for stereo system 138 or intercom 139 to communicate the audible announcement.

While in those modes in which the TV screen 133 is not normally illuminated (i.e., “off”, “idle”, and “standby”), the MPS 132 may use another means separate from the TV screen 133, such as text display 135, LED's 136, or internal speaker 137, to notify the user of the MPS 132 that media channel content is now available for consumption. Notification may also be provided via stereo system 138 or intercom 139, in case the user is away from and/or out of sight and hearing range of the MPS 132.

FIG. 1C is a diagram illustrating another exemplary embodiment of a media exchange network 160 supporting a media processing system 171 that provides indications relating to non-broadcast information when in inactive mode, in accordance with the present invention. The media exchange network 160 of FIG. 1C is similar to the media exchange network 130 of FIG. 1B. The media exchange network 160 comprises an MPS 171 at a 1st subscriber 161, a PC 183 at a 2^{nd} subscriber 182, a 3^{rd} party service provider 177, a 3^{rd} party sales provider 178, and a 3^{rd} party media provider 179. In addition, the media exchange network 160 of FIG. 1C comprises a media exchange server 180, a media storage server 181, and a broadcast channel provider 175. A WAN infrastructure 176 provides connectivity among the MPS 162, the PC 183, 3^{rd} party service provider 177, 3^{rd} party sales provider 178, media exchange server 180, media storage server 181, and 3^{rd} party media provider 179. As in the media exchange network 130 of FIG. 1B, the WAN infrastructure 176 of FIG. 1C may comprise, for example, a wired infrastructure, a wireless infrastructure, an intranet infrastructure, an Internet infrastructure, a digital subscriber loop (DSL) infrastructure, or any combination of the above. Although the illustration of FIG. 1C shows a specific complement of elements in media exchange network 160, a greater or lesser number of MPS's, PC's, etc., may be employed without departing from the scope or spirit of the present invention.

The embodiment of the present invention illustrated in FIG. 1C shows the MPS 171 as an enhanced set-top box separate from and connected to a TV 162. The MPS 171 comprises a text display 165, LED's 166, a speaker 167, and an infrared transmitter 168. The illustration of FIG. 1C also shows the connection of the MPS 171 to a stereo system 172 and an intercom 173.

The TV 162 connected to the MPS 171 is used to display media content accessible through media exchange network 160 using the MPS 171 and a control device such as, for example, remote control 164. The TV 162 may comprise a standard CRT-based TV, a high definition TV (HDTV), a plasma display system, or a projection TV. Although the MPS 171 is located within the residence of 1^{st} subscriber 161, it need not be in close proximity to TV 162. The MPS 171 and the TV 162 may be coupled using either a wired or wireless link. The PC 183 may include a PC monitor, a keyboard, and mouse. The MPS 171 and the PC 183 include functional software to support interaction with the various elements of the media exchange network 160, in accordance with various embodiments of the present invention.

As in the embodiment illustrated in FIG. 1B, the user of the MPS 171 may employ the MPS 171 to consume media channel content provided by other entities connected to media exchange network 160 such as, for example, broadcast channel provider 175, 3^{rd} party service provider 177, 3^{rd} party sales provider 178, 3^{rd} party media provider 179, media exchange server 180, media storage server 181, and 2^{nd} subscriber 182. Media channel content may be arranged for viewing/listening using a media guide interface, such as the media guide interface referenced above.

The media processing system 171 may operate in one of several states such as, for example, the “on”, “off”, “idle”, and “standby” states. During normal user access to media exchange network 160, the MPS 171 is operated in the “on” state, in which the TV screen 163 of TV 162 is illuminated and used to display, for example, selected media channel content or a user media guide interface. When in the “on” state, the user may be notified of the availability of media channel content other than that being displayed using pop-up window 170. Although shown in FIG. 1C as a distinct display region, the window 170 may be, for example, a ghost overlay or other screen display technique to make the user of the MPS 171 aware of the availability of media channel content. The media processing system 171 may also use, for example, the connections to stereo system 172 or the intercom 173 to provide an audible announcement of the availability of media content. In order to utilize the stereo system 172, the MPS 171 may use a wired or wireless link to arrange for stereo system 172 or intercom 173 to communicate the audible announcement.

During those times at which the TV 162 is powered off, the MPS 171 may use another means separate from the TV screen 163, such as text display 165, LEDs 166, or internal speaker 167, to notify the user that media channel content is now available for consumption. Such an announcement may also be provided using the connections to stereo system 172 or intercom 173, in case the user is away from the MPS 171. In addition, an embodiment in accordance with the present invention may comprise a wireless transmitter, such as infrared (IR) transmitter 168, to enable the MPS 171 to activate the TV 162, in order to notify the user of the availability of media channel content.

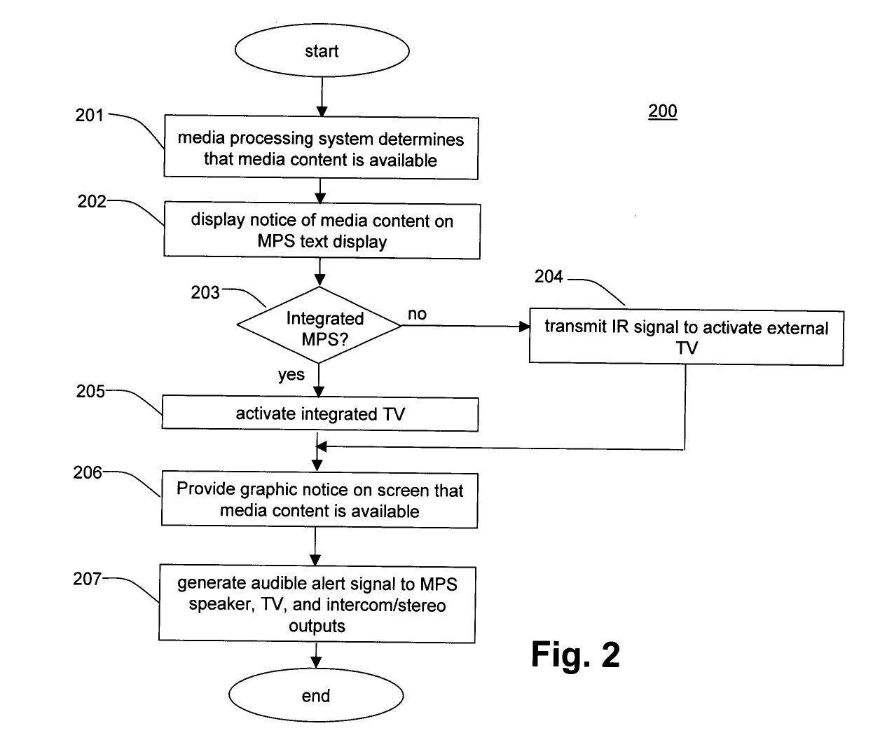

FIG. 2 is a flowchart illustrating an exemplary method of operating a media processing system providing indications relating to non-broadcast information when in an inactive mode, in accordance with the present invention. The method may be used in a media processing system with an integrated TV screen display, or one for use with an external TV. The method shown in FIG. 2 begins when the media processing system determines that media content is available (step 201). Upon determining that media content is available, the media processing system displays a notice on the text display device of the MPS (step 202). Next, a check is made as to whether the media processing system is integrated with a TV screen display, or whether an external TV is in use (step 203). If an external TV is used as the display device, the media processing system transmits an infrared signal to activate the external TV (step 204). If the MPS is integrated with the TV used as the display device, the MPS actives the integrated TV (step 205). The media processing system then generates a screen graphic for display on the integrated or external TV screen, notifying the user that media content is available (step 206). The media processing system also generates an audible alert signal using the internal speaker in the media processing system, and also sends the alert signal to any external stereo system or intercom that may be connected (step 207).

A major challenge is to be able to transfer and share many different types of digital media, data, and services between one device/location and another with ease while being able to index, manage, and store the digital media and data.

For example, it is desirable to be able to distribute and store many types of digital media in a PC and/or television environment in a user-friendly manner without requiring many different types of software applications and/or unique and dedicated interfaces. Any networking issues or other technical issues should be transparent to the users. It is also desirable to take advantage of existing hardware infrastructure, as much as possible, when providing such capability.

In an embodiment of the present invention, a media exchange network is provided that enables many types of digital media, data, and/or services to be stored, indexed, viewed, searched for, pushed from one user to another, and requested by users, using a media guide user interface. The media exchange network also allows a user to construct personal media channels that comprise his personal digital media (e.g., captured digital pictures, digital video, digital audio, etc.), request that third-party media channels be constructed from third-party digital media, and access the media channels pushed to him by other users on the media exchange network.

PC's may be used but are not required to interface to the media exchange network for the purpose of exchanging digital media, data, and services. Instead, set-top boxes or integrated MPS's (media processing systems) may be used with the media exchange network to perform all of the previously described media exchange functions using a remote control with a television screen.

Current set-top boxes may be software enhanced to create an MPS that provides full media exchange network interfacing and functionality via a TV screen with a TV guide look-and-feel. PC's may be software enhanced as well and provide the same TV guide look-and-feel. Therefore, the media exchange network supports both PC's and MPS's in a similar manner. Alternatively, a fully integrated MPS may be designed from the ground up, having full MPS capability.

In the case of an MPS configuration, the user takes advantage of his remote control and TV screen to use the media exchange network. In the case of a PC configuration, the user takes advantage of his keyboard and/or mouse to use the media exchange network.

An MPS or enhanced PC is effectively a storage and distribution platform for the exchange of personal and third party digital media, data, and services as well as for bringing the conventional television channels to a user's home. An MPS and/or PC connects to the media exchange network via an existing communication infrastructure which may include cable, DSL, satellite, etc. The connection to the communication infrastructure may be hard-wired or wireless.

The media exchange network allows users to effectively become their own broadcasters from their own homes by creating their own media channels and pushing those media channels to other authorized users on the media exchange network, such as friends and family members.

FIG. 3 comprises a media exchange network 300 for exchanging and sharing digital media, data, and services in accordance with an embodiment of the present invention. The media exchange network 300 is a secure, closed network environment that is only accessible to pre-defined users and service providers. The media exchange network of FIG. 3 comprises a first PC 301 and a first media processing system (MPS) 302 at a user's home 303, a communication infrastructure 304, external processing hardware support 305, remote media storage 306, a second PC 307 at a remote location 308 such as an office, and a second MPS 309 at a parent's home 310.

The PC's 301 and 307 and the MPS's 302 and 309 each include a media exchange software (MES) platform 311 and a networking component 312 for connectivity. The MES platform 311 provides multiple capabilities including media “push” capability, media “access” capability, media channel construction/selection, image sequence selection, text and voice overlay, channel and program naming, inter-home routing selection, authorship and media rights management, shared inter-home media experience, billing service, and an integrated media guide interface providing a TV channel guide look-and-feel.

The external processing hardware support 305 comprises at least one server such as a centralized Internet server, a peer-to-peer server, or cable head end. The server may alternatively be distributed over various hosts or remote PC's. The MES platform 311 may also reside on the external processing hardware support server 305. The remote media storage 306 may comprise user media storage and distribution systems 313 and/or third party media storage and distribution systems 314.

The communication infrastructure 304 may comprise at least one of Internet infrastructure, satellite infrastructure, cable infrastructure, dial-up infrastructure, cellular infrastructure, XDSL infrastructure, optical infrastructure, or some other infrastructure. The communication infrastructure 304 links the user's home 303, parent's home 310, remote media storage 306, and remote location office 308 to each other (i.e., the communication infrastructure 304 links all users and service providers of the media exchange network 300).

The various functions 315 of the media exchange network 300 comprise generating personal network associations, personal storage management, media capture device support, security/authentication/authorization support, authorship tracking and billing and address registration and maintenance. These media exchange management functions 315 may be distributed over various parts of the media exchange network 300. For example, the personal network associations and personal storage management functions may be integrated in the PC 301 at the user's home 303.

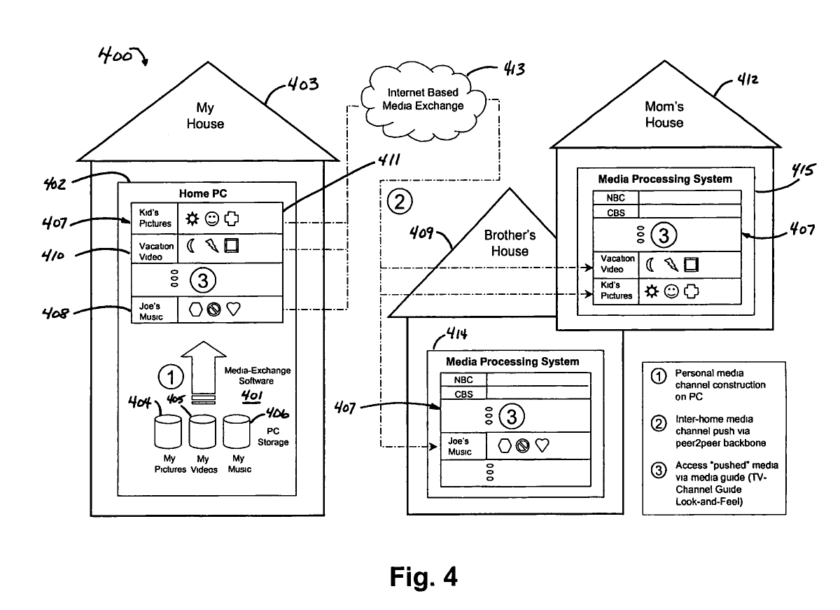

FIG. 4 illustrates an example of personal media exchange over a media exchange network 400 in accordance with an embodiment of the present invention. In step 1, the media exchange software (MES) platform 401 is used to construct personal media channels on a PC 402 by a user at “my house” 403. For example, with various media stored on the PC 402 such as digital pictures 404, videos 405, and music 406, the MES platform 401 allows the digital media to be organized by a user into several channels having a media guide user interface 407 on the PC 402.

In step 2, the user at “my house” 403 pushes a media channel 408 (e.g., “Joe's Music”) to “brother's house” 409 and pushes two media channels 410 and 411 (e.g., “Vacation Video” and “Kid's Pictures”) to “Mom's house” 412 via a peer-to-peer server 413 over the Internet-based media exchange network 400. “Brother's house” 409 includes a first MPS 414 connected to the media exchange network 400. “Mom's house” 412 includes a second MPS 415 connected to the media exchange network 400. The MPS's 414 and 415 also provide a media guide user interface 407.

In step 3, brother and/or Mom access the pushed media channels via their respective media processing systems (MPS's) 414 and 415 using their respective MPS TV screens and remote controls.

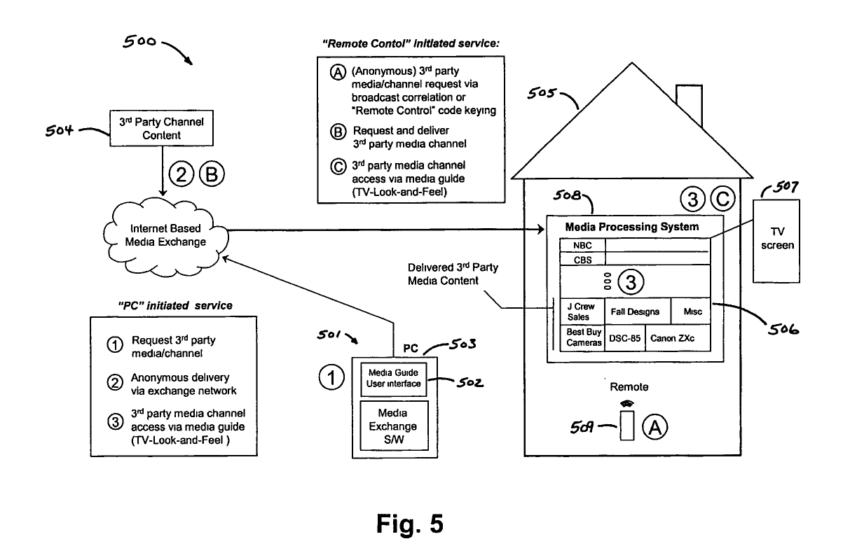

FIG. 5 illustrates an example of third-party media exchange over a media exchange network 500 in accordance with an embodiment of the present invention. In step 1, a PC-initiated third-party request is made by a first party 501 via an Internet-based media exchange network 500 using a media guide user interface 502 on a PC 503. In step 2, an anonymous delivery of the requested third-party channel 504 is made to a second party 505 via the Internet-based media exchange network 500. In step 3, the second party 505 accesses the third-party channel 504 using a media guide user interface 506 on a TV screen 507 that is integrated into an MPS 508.

Similarly, in step A, an MPS-initiated third-party request is made by a second party 505 via an Internet-based media exchange network 500 using a media guide user interface 506 on a TV screen 507 using a remote control 509. The second party 505 may key in a code, using his remote control 509, that is correlated to a commercial or some other third party broadcast media. In step B, an anonymous delivery of the requested third-party channel 504 is made to a first party 501 via the Internet-based media exchange network 500. In step C, the first party 501 accesses the third-party channel 504 using a media guide user interface 502 on a PC 503.

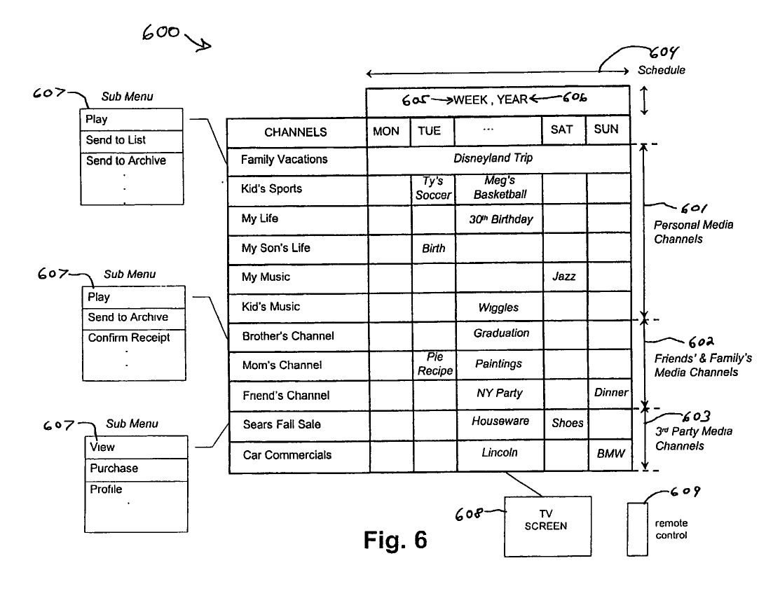

FIG. 6 illustrates a media guide user interface 600 in accordance with an embodiment of the present invention. The media guide user interface 600 may be displayed on a TV screen 608 and controlled by a remote control device 609. Also, the media guide user interface 600 may be displayed on a PC monitor and controlled by a keyboard or mouse.

The media guide user interface 600 may be configured not only for conventional TV channels but also for personal media channels 601 that are constructed by a user of a media exchange network, friend's and family's media channels 602 constructed by friends and family, and third party channels 603 that are constructed by third parties either upon request by a user of a media exchange network or based on a profile of a user.

The personal media channels 601 may include, for example, a “family vacations channel”, a “kid's sports channel”, a “my life channel”, a “son's life channel”, a “my music channel”, and a “kid's music channel”. The friends and family media channels 602 may include, for example, a “brother's channel”, a “Mom's channel”, and a “friend's channel”. The third party media channels 603 may include, for example, a “Sears Fall sale channel” and a “car commercials channel”.

Each media channel may correspond to a schedule 604 showing, for example, a week 605 and a year 606. For example, under the “kid's sports channel”, Ty's soccer game could be scheduled to be viewed on Tuesday of the current week 605 and current year 606. For each media channel, a sub-menu 607 allows for selection of certain control and access functions such as “play”, “send to list”, “send to archive”, “confirm receipt”, “view”, “purchase”, and “profile”.

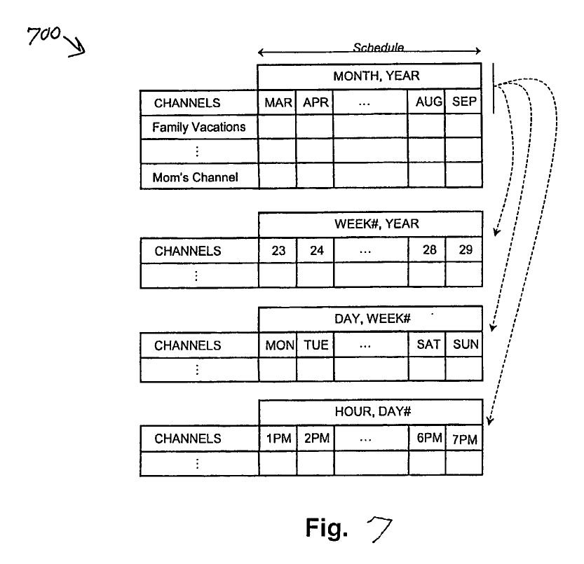

FIG. 7 illustrates possible multiple instantiations of a media guide user interface 700 in accordance with an embodiment of the present invention. The media guide user interface 700 may be viewed with a schedule having formats of, for example, “month, year”, “week#, year”, “day, week#”, or “hour, day”.

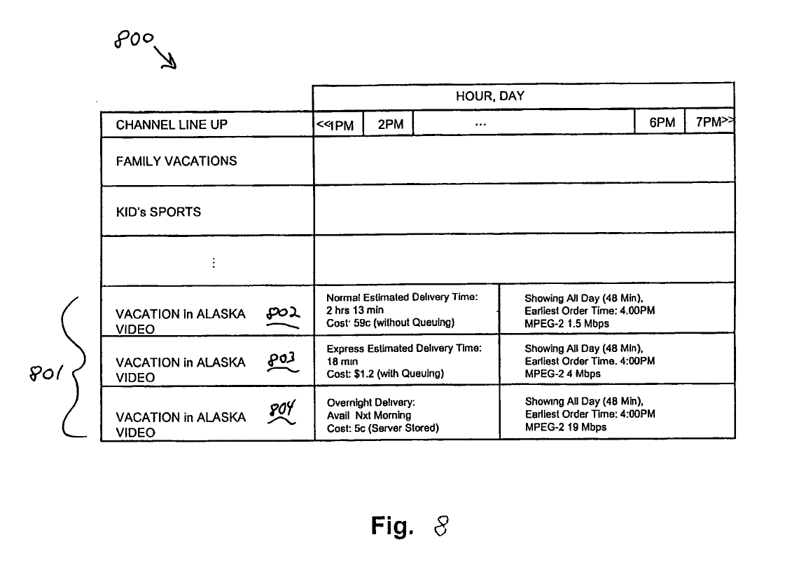

Referring to FIG. 8, a user of a media exchange network may push a media channel (e.g., “Vacation in Alaska Video”) to a friend who is on the same media exchange network. The media guide user interface 800 may give the friend several options 801 for how to accept and download the pushed media in accordance with an embodiment of the present invention.

For example, a first, most expensive option 803 may be “Express Delivery” which would deliver the pushed media to the friend in 18 minutes using queuing and cost $1.20, for example. The pushed media may be stored in a file in an MPEG 2 format that was recorded at a rate of 4 Mbps, for example. Queuing comprises buffering and delivering a previous part of the media and then buffering and delivering a next part of the media. For example, a first six minutes of the “Vacation in Alaska Video” may be buffered and delivered first, then a second six minutes may be buffered and delivered next, and so on until the entire media is delivered.

A second, less expensive option 802 may be “Normal Delivery” which would deliver the pushed media in 2 hours and 13 minutes without queuing and cost $0.59, for example. The pushed media may be stored in a file in an MPEG 2 format that was recorded at a rate of 1.5 Mbps, for example.

A third, least expensive option 804 may be “Overnight Delivery” which would deliver the pushed media by the next morning and cost only $0.05, for example. The pushed media may be stored in a file in an MPEG 2 format that was recorded at a rate of 19 Mbps and stored on a server, for example.

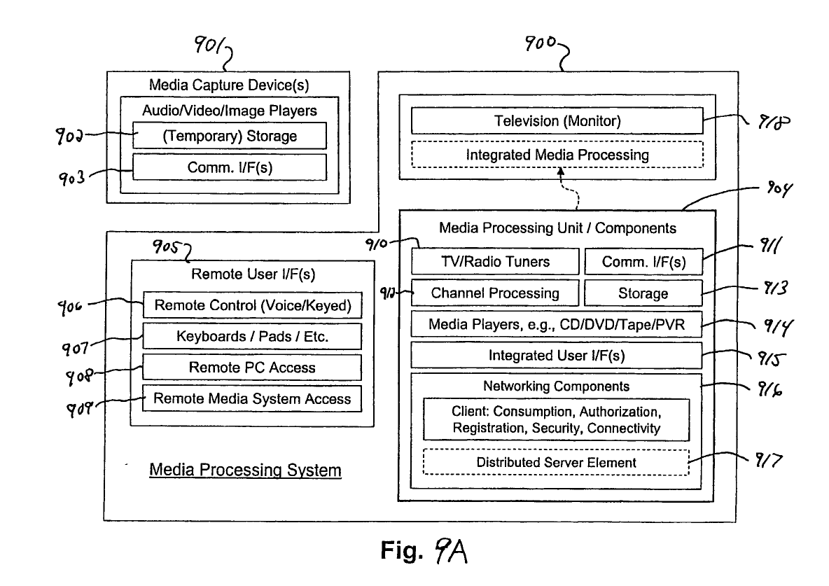

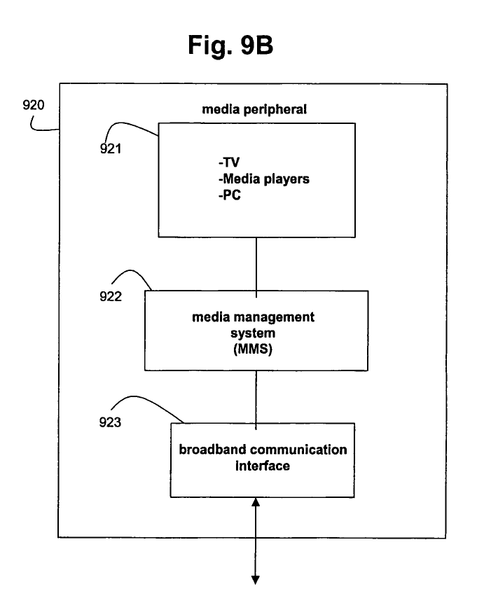

FIG. 9A illustrates the detailed elements of a media processing system (MPS) 900 and media capture devices 901 in accordance with an embodiment of the present invention. The media capture devices 901 may comprise audio, video, and image players, such as digital cameras, digital camcorders, and MP3 players, that each include a temporary storage area 902 and a communication interface 903 such as, for example, a USB interface or a wireless interface. The media capture devices 901 have the capability to interface to an MPS and a PC.

The MPS 900 comprises a media processing unit (MPU) 904, remote user interface(s) 905, and a TV screen 918 to provide integrated media processing capability and indirect user interface capability. The remote user interfaces 905 may comprise a voice or keyed remote control 906, keyboards and pads 907, a remote PC access interface 908, and a remote media system access interface 909 (i.e., providing access from another MPS).

The media processing unit (MPU) 904 comprises TV and radio tuners 910 for image and audio consumption, communications interfaces 911, channel processing 912 (creating, storing, indexing, viewing), storage 913, media players 914 (CD, DVD, Tape, PVR, MP3), an integrated user interface 915 (to provide a TV channel guide look-and-feel), networking components 916 to provide client functions such as consumption (billing), authorization (e.g., using digital certificates and digital ID's), registration, security, and connectivity. In an alternative embodiment of the present invention, the networking components 916 may include a distributed server element 917 that is part of a distributed server.

FIG. 9B illustrates an alternative embodiment of a media processing system (MPS) 920 in accordance with various aspects of the present invention. The MPS 920 is essentially an enhanced set-top box for viewing and interacting with various user interfaces, media, data, and services that are available on the media exchange network using, for example, a remote control. The MPS 920 comprises a media peripheral 921, a MMS (media management system) 922, and a broadband communication interface 923.

The media peripheral 921 may include a TV (television), a PC (personal computer), and media players (e.g., a CD player, a DVD player, a tape player, and an MP3 player) for video, image, and audio consumption of broadcast and/or personal channels. The broadband communication interface 923 may include internal modems (e.g., a cable modem or DSL modem) or other interface devices in order to communicate with, for example, a cable or satellite headend.

The MMS 922 includes a software platform to provide functionality including media “push” capability, media “access” capability, media channel construction/selection, image sequence selection, text and voice overlay, channel and program naming, inter-home routing selection, authorship and media rights management, shared inter-home media experience, billing service, and a media guide user interface providing an integrated TV channel guide look-and-feel.

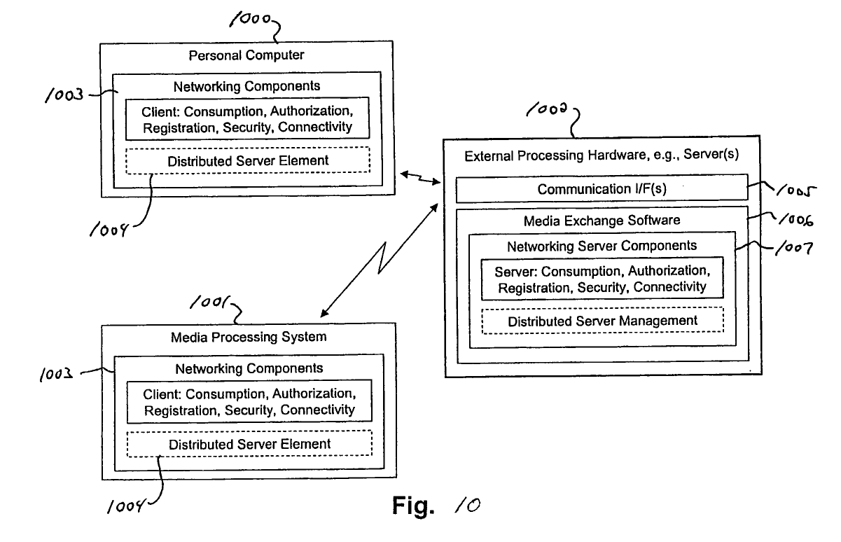

FIG. 10 illustrates connectivity between a PC 1000, an MPS 1001, and external processing hardware 1002 (e.g., a server) in accordance with an embodiment of the present invention. The PC 1000 and MPS 1001 include networking components 1003 to provide client functions such as consumption (billing), authorization, registration, security, and connectivity. Alternatively, the PC 1000 and MPS 1001 may include a distributed server element 1004 that is part of a distributed server.

The PC 1000 and MPS 1001 connect to the external processing hardware 1002 via wired or wireless connections. The external processing hardware 1002 comprises a distributed server or peer-to-peer server. The external processing hardware 1002 also comprises communication interfaces 1005 (e.g., cable interfaces, optical interfaces, etc.) and a media exchange software (MES) platform 1006. The MES platform 1006 in the external processing hardware 1002 allows for communication with the PC 1000 and MPS 1001 which may also use the same MES platform 1006. The external processing hardware 1002 also includes networking server components 1007 to provide the similar client functions such as consumption (billing), authorization, registration, security, and connectivity at the server side.

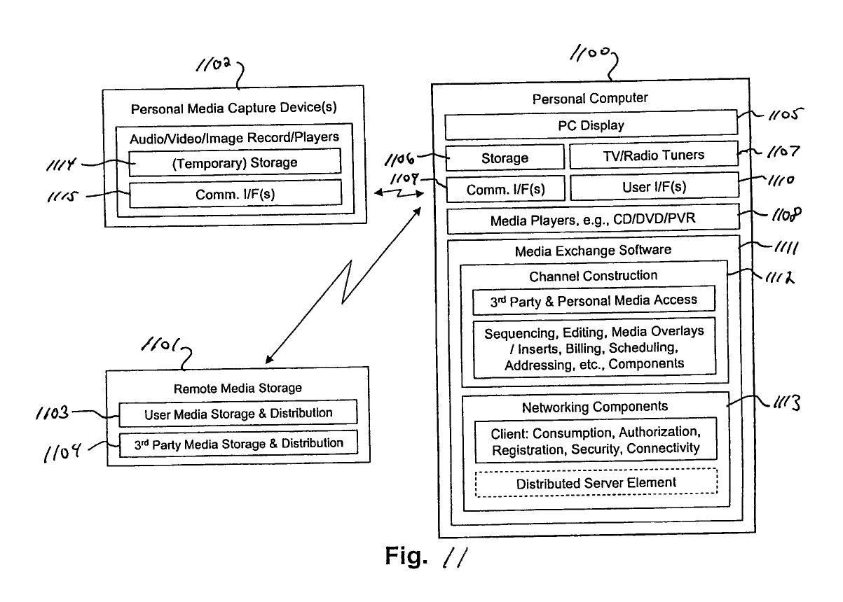

FIG. 11 illustrates connectivity between a PC 1100, remote media storage 1101, and personal media capture devices 1102 when the PC 1100 is used as the primary distributor of digital media such as in the case of PC-to-PC operation, in accordance with an embodiment of the present invention. The personal media capture devices 1102 and remote media storage 1101 connect to the PC 1100 via a wireless or wired connection. The remote media storage 1101 provides user media storage and distribution 1103 as well as third party media storage and distribution 1104. The personal media capture devices 1102 provide temporary storage 1114 and communication interfaces 1115.

Viewing is done using a PC monitor 1105 sinstead of a television screen. The PC 1100 may include storage 1106, TV/radio tuners 1107 for media consumption, media players 1108, and communication interfaces 1109 and user interfaces 1110 similar to those for the MPS of FIG. 9A. The PC 1100 includes a media exchange software (MES) platform 1111 that provides channel construction capability 1112 and networking capability 1113. The channel construction capability 1112 allows third party and personal media access, sequencing, editing, media overlays and inserts, billing, scheduling, and addressing.

In summary, a system and method provide support for a television providing indications relating to non-broadcast information when in inactive mode.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A system for managing newly accessible media content on a communication network, comprising:
a display communicatively coupled to at least one communication device, the communication device being in at least one of a “standby” mode and an “off” mode;
a communication network communicatively coupled to the at least one communication device; and
media content disposed in at least one of the communication network and the at least one communication device, the at least communication device adapted to detect the media content that is newly accessible to the at least one communication device and to provide indications relating to the detection of the newly available media content, the indications being provided on at least one of the display and the at least one communication device.

2. The system according to claim 1, wherein the communication network comprises at least one of a third party media server, a media exchange server, a third party media provider, a third party service provider, a media storage server, a broadband access headend, a broadcast channel provider, a cable infrastructure, a satellite network infrastructure, a digital subscriber line (DSL) infrastructure, an Internet infrastructure, an intranet infrastructure, a wired infrastructure, a closed communication infrastructure, a local area network, and a wireless infrastructure.

3. The system according to claim 1, wherein the communication network comprises an Internet.

4. The system according to claim 1, wherein the at least one communication device comprises at least one of a computer, a storage device, a media peripheral, set-top box circuitry, a television, a text display, a keyboard, a computer mouse, a remote control, an internal speaker, an intercom system, an infrared transmitter, light emitting diodes (LED's), and a stereo system.

5. The system according to claim 1, wherein the display is at least one of a CRT-based television, a high definition TV (HDTV), a plasma display system, and a projection television.

6. The system according to claim 1, wherein the media content comprises at least one of third party media content, user-created media content, digital video, digital images, digital audio, documents, files, non-broadcast media content, broadcast television programs, radio channels, news programming, sporting events programming, special programming, and on-demand movies.

7. The system according to claim 6, wherein the media content comprises non-broadcast information.

8. The system according to claim 1, wherein the indications relating to the detection of the newly available media content comprise at least one of display pop-up window notification, and display ghost overlay notification.

9. The system according to claim 8, wherein the display is in a “standby” mode.

10. The system according to claim 1, wherein the indications relating to the detection of the newly available media content comprise at least one of text display announcement, activating LED's, and an audible announcement.

11. The system according to claim 10, wherein the display is in an “off” mode.

12. A system for managing newly accessible media content on a communication network, comprising:
at least one processor disposed in a communication device, the communication device being in a “standby” mode and communicatively coupled to a communication network, the at least one processor detecting newly accessible media content on the communication network and providing indications relating to the detection of newly available media content.

13. The system according to claim 12, wherein the communication device comprises at least one of a computer, a storage device, a media peripheral, set-top box circuitry, a television, a text display, a keyboard, a computer mouse, a remote control, an internal speaker, an intercom system, an infrared transmitter, light emitting diodes (LED's), and a stereo system.

14. The system according to claim 12, wherein the indications relating to the detection of the newly available media content comprise at least one of display pop-up window notification, display ghost overlay notification, text display announcement, activating LED's, and an audible announcement.

15. A method for managing newly accessible media content on a communication network, comprising:
(a) detecting newly available media content by a communication device in at least one of a “standby” mode and an “off” mode, the communication device communicatively coupled to a communication network; and
(b) generating at least one indication relating to the detection of newly available media content.

16. The method according to claim 15, wherein the at least one indication is in at least one of a text format, a graphic format, and an audio format.

17. The method according to claim 15, wherein the at least one indication relating to the detection of the newly available media content comprise at least one of display pop-up window notification, display ghost overlay notification, text display announcement, activating LED's, and an audible announcement.

18. The method according to claim 15, further comprising:
(c) displaying the constructed at least one indication on the communication device, the communication device being in a “standby” mode.

19. A method for managing newly accessible media content on a communication network, comprising:
(a) detecting newly accessible media content by a communication device, the communication device communicatively coupled to a communication network;
(b) displaying a notice relating to the availability of the newly accessible media content on a text display, the text display communicatively coupled to the communication device;
(c) activating at least one of an integrated television and an external television; and
(d) displaying a graphic notice for the availability of the newly accessible media content on at least one of the integrated television and the external television.

20. The method according to claim 19, wherein at least one of the integrated television and the external television is in a “standby” mode.

21. The method according to claim 19, further comprising:
(e) generating an audible alert signal for the availability of the newly accessible media content.

22. The method according to claim 21, wherein at least one of the integrated television and the external television is in an “off” mode.
